(19) United States
(12) Patent Application Publication
(10) Pub. No.: US 2002/0178248 A1
(43) Pub. Date: Nov. 28, 2002

(54) Application program interface for optimization integration model

(75) Inventor: Carlos M. Collazo, Redwood Shores, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: MetiLinx, San Mateo, CA (US)

(21) Appl. No.: 10/055,404

(22) Filed: Oct. 26, 2001

Related U.S. Application Data
(60) Provisional application No. 60/243,783, filed on Oct. 26, 2000.

(51) Int. Cl. G06F 15/173

(52) U.S. Cl. 709/223

(57) ABSTRACT

An application program interface for a network optimization system. The interface provides functions, objects, procedures and other processes or functionality for controlling a network optimization system as described herein and in the related applications. In one embodiment the invention provides an interface providing dual interface support for scripting languages.

### CLAIM OF PRIORITY

This application claims priority from U.S. Provisional Patent Application No. 60/243,783, filed Oct. 26, 2000.

### CROSS-REFERENCES TO RELATED APPLICATIONS

This application is related to the following co-pending applications, each of which is incorporated by reference as if set forth in full in this application:

U.S. patent application entitled “System-Wide Optimization Integration Model” (020897-000110US) filed on Oct. 12, 2001, [Ser. No. ______ [TBA];] Ser. No. 09/976,368: U.S. patent application entitled “Multi-Platform Optimization Model” (020897-000120US) filed on Oct. 12, 2001, [Ser. No. ______ [TBA];] Ser. No. 09/976,518: and U.S. patent application entitled “Aggregate System Resource Analysis Including Correlation Matrix and Metric-Based Analysis” (020897-000130US) filed on Oct. 26, 2001, [Ser. No. ______ [TBA].] Ser. No. 10/040,012.

### COPYRIGHT NOTICE

A portion of the disclosure recited in this specification contains material which is subject to copyright protection. Specifically, a Source Code Appendix in accordance with 37 CFR Section 1.96 is included that lists source code instructions for a process by which the present invention is practiced in a computer system. The Source Code Appendix comprises [TBD] sheets of microfiche containing 166 frames, or pages, of source code. The copyright owner has no objection to the facsimile reproduction of the specification as filed in the Patent and Trademark Office. Otherwise all copyright rights are reserved.

### BACKGROUND OF THE INVENTION

Digital computer networks, such as the Internet, are now used extensively in many aspects of commerce, education, research and entertainment. Because of the need to handle high volumes of traffic, many Internet sites are designed using several groups of server computers. An example of a site network system is shown in FIG. 1A.

In FIG. 1A, network system 10 includes four major tiers. These are communications tier 12, web tier 14, application tier 16 and database tier 18. Each tier represents an interface between a group of server computers or other processing, storage or communication systems. Each interface handles communication between two groups of server computers. Note that the tiers are significant in that they represent the communication protocols, routing, traffic control and other features relating to transfer of information between the groups of server computers. As is known in the art, software and hardware is used to perform the communication function represented by each tier.

Server computers are illustrated by boxes such as 20. Database 22 and Internet 24 are represented symbolically and can contain any number of servers, processing systems or other devices. A server in a group typically communicates with one or more computers in adjacent groups as defined and controlled by the tier between the groups. For example, a request for information (e.g., records from a database) is received from the Internet and is directed to server computer 26 in the Web-Com Servers group. The communication takes place in communications tier 12.

Server computer 26 may require processing by multiple computers in the Application Servers group such as computers 20, 28 and 30. Such a request for processing is transferred over web tier 14. Next, the requested computers in the Application Servers group may invoke computers 32, 34, 36 and 38 in the Database Servers group via application tier 16. Finally, the invoked computers make requests of database 22 via database tier 18. The returned records are propagated back through the tiers and servers to Internet 24 to fulfill the request for information.

Of particular concern in today's large and complex network systems is monitoring the performance of, and optimizing, the system. One way that prior art approaches monitor system performance is to use a process at certain points in the network to report data back to a central location such as console 40. In FIG. 1A, the request for database records can be monitored by having a process at server 26 log the time and nature of the request. A process at server 20 then logs the time at which a request from server 26 is received. Similarly, server 32 (or whichever server receives the database request from server 20) logs its participation in the transaction. This “chain” of logged transactions is illustrated by bold arrows in FIG. 1A.

In this manner, the prior art monitoring system can determine how long it takes for a request for a record to propagate through the network. The transaction can also be tracked in the other direction to determine how long it takes to fulfill the request. The nature of such data logging is complex since a server in one tier, or group, may ask multiple other servers for assistance, or processing. Also, different servers can be asked at different points in time. The speed at which requests, processing and transactions occur can cause large amounts of data to be logged very rapidly. At some later time, the data is transferred to console 40. Console 40 acts to resolve the data and produce meaningful results about system performance that can be analyzed by a human administrator.

A problem with the prior art approach is that the logging processes are segregated and do little, if any, communication with each other. This means that complex dependencies among processes, servers, etc., are not accurately analyzed. The logging processes tend to create high overhead in the host servers in which they execute. One approach uses the console to poll the processes. Frequent polling of many processes also creates excessive overhead. Optimization and performance improvement based on the prior art approach is hampered by the use of disparate platforms and the lack of more encompassing analysis. Having to dump data to the console at intervals, and then have the data resolved, ultimately means that monitoring is not performed in real time.

Thus, it is desirable to provide a system that improves upon one or more shortcomings in the prior art.

### BRIEF SUMMARY OF THE INVENTION

The invention provides an application program interface for a network optimization system. The interface provides functions, objects, procedures and other processes or functionality for controlling a network optimization system as described herein and in the related applications. In one embodiment the invention provides an interface providing dual interface support for scripting languages.

### BRIEF DESCRIPTION OF THE DRAWINGS

FIG. 1A shows network performance measured in a prior art system;

FIG. 1B shows network performance measured according to the present invention;

FIG. 2A shows intelligence objects and performance value passing in the present invention;

FIG. 2B illustrates architectural components of the present invention; and

FIG. 2C illustrates a network system with multiple platforms.

### DETAILED DESCRIPTION OF THE INVENTION

A preferred embodiment of the present invention is incorporated into products, documentation and other systems and materials created and distributed by MetiLinx, Inc. as a suite of products referred to as “Metilinx iSystem Enterprise” system. The Metilinx system is designed to monitor and optimize digital networks, especially networks of many computer servers in large Internet applications such as technical support centers, web page servers, database access, etc. A description and examples of scripting language and source code relating to the interface of the present invention can be found in the Source Code Appendix accompanying this specification.

The system of the present invention uses software mechanisms called “intelligence objects” (IOs) executing on the various servers, computers, or other processing platforms, in a network. The intelligence objects are used to obtain information on the performance of a process or processes, hardware operation, resource usage, or other factors affecting network performance. Values are passed among the intelligence objects so that a composite value that indicates the performance of a greater portion of the network can be derived.

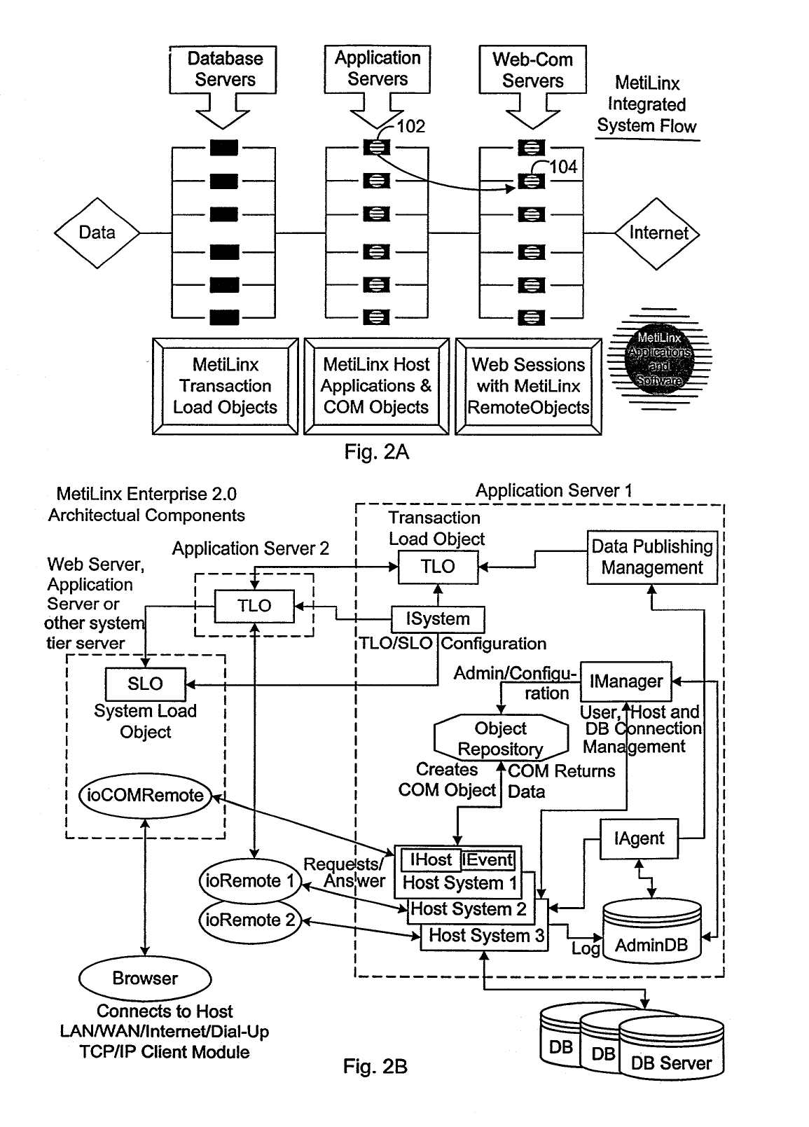

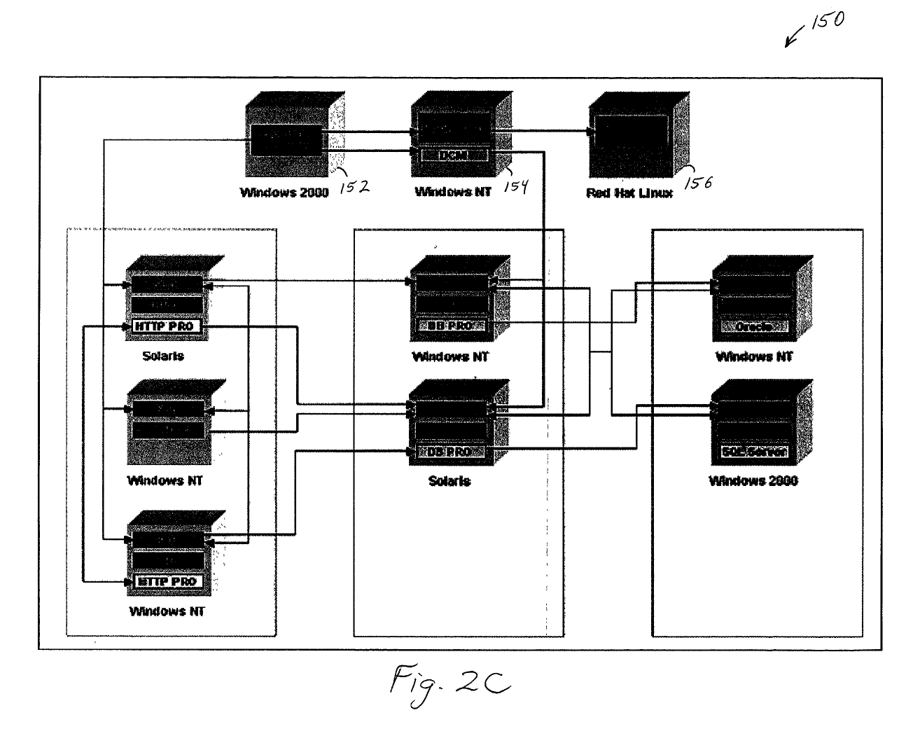

FIG. 2A illustrates intelligence objects and value passing. In FIG. 2A, intelligence objects such as 102 and 104 reside in computer servers. Any number of intelligence objects can reside in a server computer and any number of server computers in the n-tiered system can be equipped with one or more intelligence objects. A first type of intelligence object is a software process called a system level object (SLO) that can monitor and report on one or more aspects of other processes or hardware operating in its host computer server. A second type of intelligence object, called a transaction level object (TLO) is designed to monitor transaction load with respect to its host computer or processes executing within the host computer.

In one embodiment, IO 102 measures a performance characteristic of its host computer and represents the characteristic as a binary value. This value is referred to as the “local” utilization value since it is a measure of only the host computer, or of transaction information relating to the host computer. The local utilization value is passed to IO 104. IO 104 can modify the passed value to include a measurement of its own host computer. The modified value is referred to as a “composite” utilization value. The composite utilization value can, in turn, be passed on to other intelligence objects that continue to build on, or add to, the measurements so that performance across multiple computer, tiers, operating systems, applications, etc., is achieved.

Ultimately, the utilization value, or values, is passed on to other processes which can display the result of the combined measurements to a human user, use the result to derive other results, use the result to automate optimization of the n-tiered system, or use the result for other purposes. One aspect of the invention provides for redirecting processes and interconnections on the network based on the assessed utilization values of the computers, or nodes, in order to improve, or optimize, network performance. The processes that perform the redirection are referred to as “process redirection objects.”

Note that although the invention is sometimes discussed with respect to a multi-tiered server arrangement that any arrangement of servers, computers, digital processors, etc., is possible. The term “processing device” is used to refer to any hardware capable of performing a function on data. Processing devices include servers, computers, digital processors, storage devices, network devices, input/output devices, etc. Networks need not be in a multi-tiered arrangement of processing devices but can use any arrangement, topology, interconnection, etc. Any type of physical or logical organization of a network is adaptable for use with the present invention.

FIG. 2B illustrates one possible arrangement of more specific components of the present invention. Note that the term “component” as used in this specification includes any type of processing device, hardware or software that may exist within, or may be executed by, a digital processor or system.

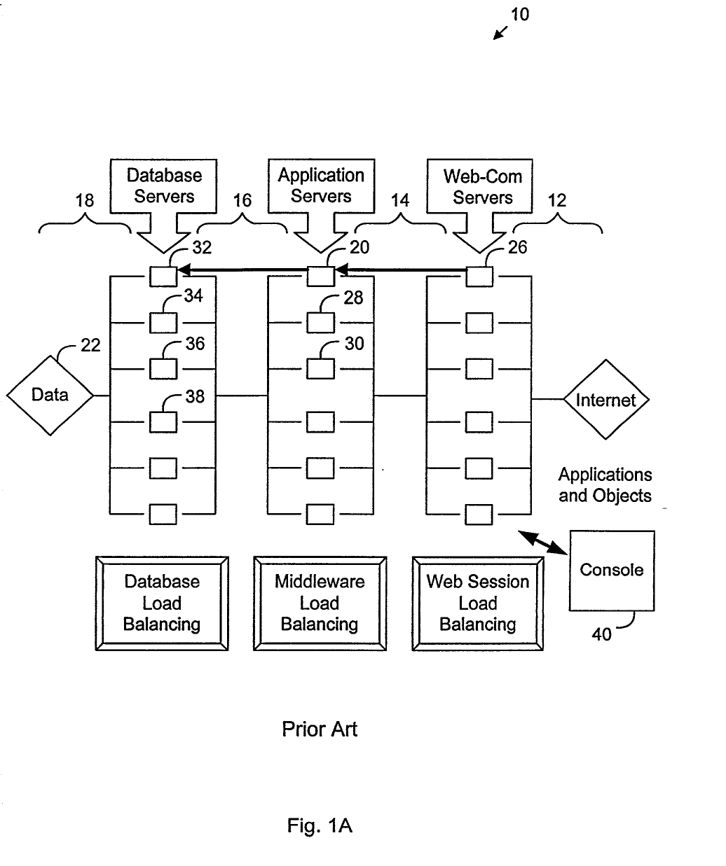

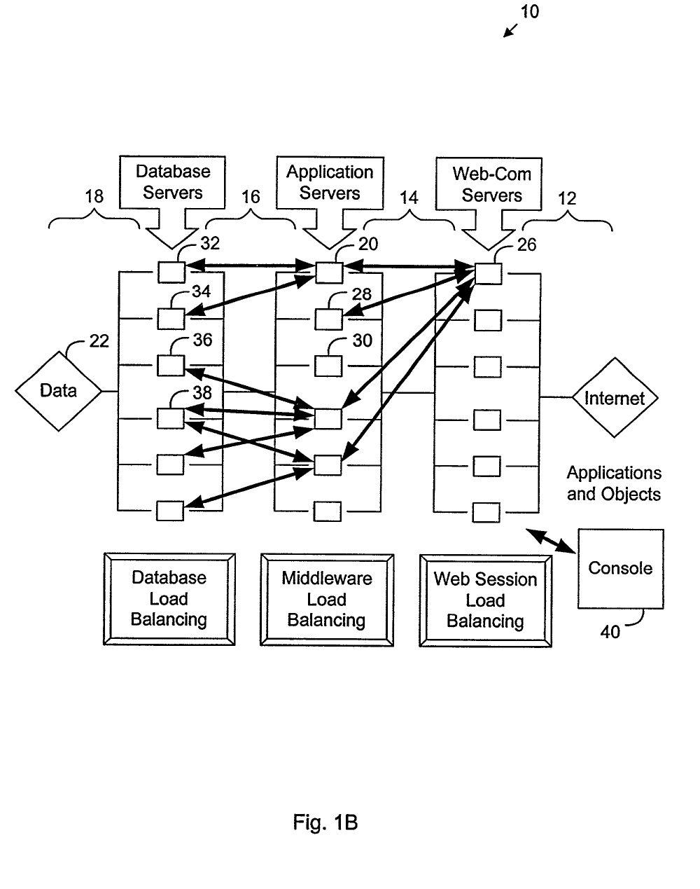

Systems such as those illustrated in FIGS. 1, 2A and 2B, along with virtually any type of networked system, can be provided with IOs. In a preferred embodiment, the IOs are installed on each server in the network in a distributed peer-to-peer architecture. The IOs measure real-time behavior of the servers components, resources, etc. to achieve an overall measure of the behavior and performance of the network.

A software system for populating a network with nodes, and for monitoring, analyzing, managing and optimizing a network is provided in the co-pending applications cited above.

A preferred embodiment collects data on low-level system and network parameters such as CPU utilization, network utilization, latency, etc. About 400 different measured characteristics are used.

Data is produced at each node as a four-byte value reflecting the characteristics of the host processing system for the node. These values are referred to as Local Node Values (LNVs). Multiple LNVs from different nodes are combined into a composite value called a Composite Node Value (CNV). CNVs can also include CNVs passed by other nodes.

The CNVs remain four-bytes in size. A CNV is passed along the network hierarchy and used to obtain further composite values by combining with a LNV at successive nodes so that overall system performance is ultimately provided in the composite values. Node value propagation is typically organized into organizational and functional blocks, as described in the related applications. Typically, node value propagation is in the direction of dependencies, or counter to request flow. However, since request flow and dependencies are loosely adhered to in any particular network (and can change with time) the system of the present invention can adapt to changing conditions. In general, the passing of node values can change dynamically, can be one-to-many or many-to-one and is bidirectional. Thus, unlike the limited directional “chaining” of prior art systems as shown in FIG. 1A, the system of the present invention can provide flexible peer-to-peer value passing. Performance and usage information from many nodes can be combined in varied patterns to achieve more versatile analysis structures such as that illustrated in FIG. 1B (by bold arrows).

Naturally, in other embodiments, the local and composite values can be of any size, varying sizes, etc. The values can be more complex data structures as opposed to “values.” Any combination of network characteristics can be measured.

LNVs and CNVs are made up of four sub-values. Each sub-value is a byte of data with a higher value (e.g., 255) indicating optimal functioning in the sub-value's associated network property. A first sub-value is a System Balance Value (SBV). The SBV measures the balanced operation of server nodes within functional groups. Functional groups are designated by a user/administrator and are used by the system of the present invention to define groups among which CNVs accumulate values. A higher SBV value indicates that functional groupings of server nodes are operating in good balance.

A second sub-value is the System Utilization Value (SUV). The SUV represents the system resource utilization, based on analyses of individual and aggregated resource nodes. A higher values indicates that resources are being utilized more efficiently.

A third sub-value is the Performance Optimization Value (POV). The POV represents the metric for speed or response of the system resources. A higher value means that response times are shorter, or that speed of response is higher.

A fourth, and final, sub-value is called the MetiLinx Optimization Value (MOV). The MOV indicates the degree of total system optimization. A high value indicates that functional groups are more optimally balanced. The MOV reflects the other sub-values of balance, resource utilization and speed of response.

In order to meaningfully composite LNV and CNV values received from other nodes, each node maintains a “correlation matrix.” The correlation matrix includes numerical weighting factors based on differences in characteristics of different node environments in the network. For example, best performance values can be maintained for every node in the system. Node A might be recorded at a best performance combination of 90% utilization and a 3 second response. Node B might have a 90% utilization with a 2 second response. When node C receives LNV or CNV values indicating 90% utilization with a 3 second response for each node, node C is now aware that node A's host environment is operating at a high performance while node B's environment is operating at a lower than desired utilization since the response time is slower than previously achieved. In generating a CNV from node A and B values, node C's process combines the utilization and response times by weighting according to the correlation matrix. In this simplified example, if “A” is the dependency of node C on node A's utilization (for node C's efficient operation and utilization), while “B” is the dependency of node C on node B's utilization, then the CNV at node C can be computed as A+(B*2)/3.

Each node's correlation matrix is updated based on information the node receives from other nodes. For example, if node C is informed that node B is now operating at 90% utilization with a 1 second response time, node C's correlation matrix factors with respect to node B are updated. Note that the correlation matrix is multi-dimensional. With the simplified example, alone, there can be a two dimensional array for utilization versus response time for each node.

In a preferred embodiment the correlation matrix is stored locally to the node process. Usually the correlation matrix resides in fast RAM in the node's host processing system. However, other embodiments can use variations on the correlation matrix and can maintain and access the correlation matrix in different ways. For example, correlation matrices can be stored on, and accessed from, a central console computer.

Nodes may be removed from the network as, for example, when an administrator deactivates the node, the node's host processor is brought down, etc. When a node is brought down the optimization system traffic of the present invention is routed to different nodes. It is advantageous to transfer the correlation matrix of the node taken down to the one or more nodes to which traffic is being re-routed so that the information in the correlation matrix does not have to be recreated.

A preferred embodiment of the invention uses varying latency cycles to allow nodes to gather characteristics data to generate local values at varying frequencies. For example, a latency cycle can vary from 0 to 100. A larger number means that a characteristic is obtained less frequently. A value of 0 for a latency cycle means that a characteristic value is obtained as often as possible. Naturally, a lower latency cycle means that the host CPU is spending more time acquiring characteristic data and, possibly, generating values, also.

Although the present invention has been discussed with respect to specific embodiments, these embodiments are merely illustrative, and not restrictive, of the invention.

Thus, the scope of the invention is to be determined solely by the appended claims.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. An application program interface for a network optimization system, the interface comprising
dual interface support for scripting languages.

2. An application program interface for a network optimization system, the interface comprising
an interface for loading a data object, the interface for loading a data object comprising one or more of the following:
a procedure for obtaining a data server;
a procedure for obtaining a connection string;
a procedure for closing a connection; and
a procedure for opening a connection.

3. An application program interface for a network optimization system as substantially described in this application.
